(19) United States
(12) Patent Application Publication
(10) Pub. No.: US 2019/0225754 A1
(43) Pub. Date: Jul. 25, 2019

(54) POLYIMIDE PRECURSOR SOLUTION, MOLDED ARTICLE, AND METHOD FOR PRODUCING MOLDED ARTICLE

(71) Applicant: FUJI XEROX CO., LTD., TOKYO (JP)

(72) Inventors: Katsumi NUKADA, Kanagawa (JP); Tomoya SASAKI, Kanagawa (JP); Hidekazu HIROSE, Kanagawa (JP)

(73) Assignee: FUJI XEROX CO., LTD., TOKYO (JP)

(21) Appl. No.: 16/052,642

(22) Filed: Aug. 2, 2018

(30) Foreign Application Priority Data
Jan. 25, 2018 (JP) 2018-010346

(51) Int. Cl. C08G 73/10; C08J 9/26; C08J 9/00; C08K 3/38; C08K 3/22

(52) U.S. Cl. CPC C08G 73/1067; C08J 9/26; C08J 9/0066; C08K 3/38; C08K 2003/2227; C08J 2201/046; C08J 2379/08; C08K 2003/385; C08K 3/22

(57) ABSTRACT

A polyimide precursor solution includes an aqueous solution that contains water; a resin particle that does not dissolve in the aqueous solution; an inorganic particle; and a polyimide precursor.

### CROSS-REFERENCE TO RELATED APPLICATIONS

This application is based on and claims priority under 35 USC 119 from Japanese Patent Application No. 2018-010346 filed Jan. 25, 2018.

### BACKGROUND

### (i) Technical Field

The present invention relates to a polyimide precursor solution, a molded article, and a method for producing a molded article.

### (ii) Related Art

A polyimide resin is a material having excellent characteristics of mechanical strength, chemical stability, and heat resistance, and a porous polyimide film having these characteristics is attracting attention.

For example, JP5331627B discloses a method for manufacturing a lithium secondary battery separator, in which closest packed deposits of monodisperse spherical inorganic particles are sintered to forma sintered body of the inorganic particles, interstices between the inorganic particles of the sintered body are filled with polyamic acid and are sintered thereafter so as to form a polyimide resin, and then, the polyimide resin is immersed into a solution in which the inorganic particles dissolve but the resin does not dissolve so that the inorganic particles dissolve to be removed.

JP2016-183333A discloses a method for manufacturing a resin particle-dispersed polyimide precursor solution, in which in a resin particle dispersion in which resin particles are dispersed in an aqueous solution, tetracarboxylic dianhydride and a diamine compound are polymerized in the presence of an organic amine compound, thereby forming a polyimide precursor, and discloses a polyimide film obtained by using the resin particle-dispersed polyimide precursor solution.

WO2014/196656A discloses a method for manufacturing a polyimide film by using a polyamic acid-mixed solution in which particles such as resin particles are dispersed, the solution containing an aprotic polar solvent which is a good solvent for polyamic acid, particles such as resin particles, and a mixed organic solvent such as ethanol which is a poor solvent for polyamic acid.

JP2010-024385A discloses a method for manufacturing a porous resin film, the method including a step of preparing a resin composition for the film by mixing a heat-resistant resin such as polyimide, a heat-extinctive resin particle containing polyoxyalkylene resin, and a solvent, a step of applying the resin composition for the film, and a step of heating the applied resin composition for the film.

JP1998-302749A discloses a non-aqueous electrolyte secondary battery including a positive electrode, a negative electrode, and a separator layer that contains a porous polyimide film which is formed into the porous film by phase separation after applying a solution of polyimide or a polyimide precursor, and which has an average pore diameter of 5 μm or smaller.

JP2007-197650A discloses a foamed substrate obtained by thermoplastic polyimide foams.

JP2017-016862A discloses an insulated wire in which an insulating layer has a matrix containing a synthetic resin such as polyimide as a main component, and plural heat dissipating fillers and plural pores dispersed in the matrix, and in which a heat conductivity in a thickness direction at 25° C. is 0.2 W/(m·K) or higher.

JP2017-091627A discloses an insulated wire in which an insulating layer has a matrix containing a synthetic resin such as polyimide as a main component, and plural fillers and plural pores dispersed in the matrix, and in which storage modulus is 3.0 GPa or more.

### SUMMARY

Heat conductivity of air is about 0.024 W/(m·K), which is lower than heat conductivity of polyimide, and therefore, as a void volume of a porous polyimide film becomes large, the heat conductivity is likely to be lowered. On the other hand, in a case of excessively increasing the heat conductivity in order to improve the heat conductivity of the porous polyimide film, a relative dielectric constant of the porous film excessively increases in some cases.

Aspects of non-limiting embodiments of the present disclosure relate to a polyimide precursor solution capable of obtaining a molded article having at least one layer of a porous polyimide film in which an increase in a relative dielectric constant is suppressed and heat conductivity is improved, compared to a case in which a polyimide precursor solution merely contains an aqueous solution that contains water, resin particles that do not dissolve in the aqueous solution containing water, an organic amine compound, and a polyimide precursor, in a polyimide precursor solution containing an aqueous solution that contains water, resin particles that do not dissolve in the aqueous solution, and a polyimide precursor.

Aspects of certain non-limiting embodiments of the present disclosure overcome the above disadvantages and other disadvantages not described above. However, aspects of the non-limiting embodiments are not required to overcome the disadvantages described above, and aspects of the non-limiting embodiments of the present disclosure may not overcome any of the problems described above.

According to an aspect of the present disclosure, there is provided a polyimide precursor solution including an aqueous solution that contains water; a resin particle that does not dissolve in the aqueous solution; an inorganic particle; and a polyimide precursor.

### DETAILED DESCRIPTION

Hereinafter, an exemplary embodiment that is an example of the invention will be described.

Polyimide Precursor Solution

A polyimide precursor solution according to this exemplary embodiment includes an aqueous solution that contains water; a resin particle that does not dissolve in the aqueous solution; an inorganic particle; and a polyimide precursor.

In this specification, the phrase “does not dissolve” means that a target substance dissolves in a target liquid at 25° C. by a range of 3% by mass or less.

Physical properties of a porous film depend on a shape and a size of pores. For example, in a case where the shape and the size of the pores are not uniform, in a case where the porous film is viewed from a microscopic (micro) viewpoint, distribution of dielectric characteristics and distribution of withstand voltage characteristics easily occur. As the distribution of the shape and the size of the pores of the porous film becomes small, these characteristics become in a state close to a uniform state.

For example, the porous polyimide film formed by using the polyimide precursor solution containing the aqueous solution that contains water, the resin particle that does not dissolve in the aqueous solution, and the polyimide precursor, has the pores in a state where the shape and the size are close to the uniform state. Meanwhile, heat conductivity of polyimide is about 0.16 W/(m·K), whereas heat conductivity of air is about 0.024 W/(m·K), and therefore in the porous polyimide film, as a void volume becomes larger, the heat conductivity becomes likely to decrease. Therefore, in a case where the porous polyimide film is applied as, for example, a molded article having an object generating heat (electronic device, electric wire, and the like), heat dissipation is unlikely to occur in some cases.

In contrast, the polyimide precursor solution according to this exemplary embodiment includes the inorganic particle in addition to the aqueous solution that contains water; the resin particle that does not dissolve in the aqueous solution; and the polyimide precursor. By using this polyimide precursor solution, a molded article having at least one layer of a porous polyimide film in which an increase in a relative dielectric constant is suppressed and heat conductivity is improved, may be obtained. By incorporating inorganic particles into the polyimide precursor solution, in the porous polyimide film thus obtained, the heat conductivity is improved. In addition, even in a case where the porous polyimide film contains the inorganic particles, the increase in the relative dielectric constant may be suppressed (for example, the relative dielectric constant is suppressed to a range of 15% increase or less with respect to a relative dielectric constant of the polyimide film).

Hereinafter, the polyimide precursor solution according to this exemplary embodiment and the method for producing thereof will be described.

Method for Producing Polyimide Precursor Solution

Examples of the method for producing the polyimide precursor solution according to this exemplary embodiment include the following method.

First, a resin particle dispersion in which the resin particles are dispersed in the aqueous solution is prepared. Thereafter, the inorganic particles are dispersed in the resin particle dispersion, and then, for example, in the presence of an organic amine compound, tetracarboxylic dianhydride and a diamine compound are polymerized, and therefore the polyimide precursor is formed. Hereinafter, the case in which the reaction is performed in the presence of the organic amine compound will be described.

Specifically, the case includes a step of preparing the resin particle dispersion in which the resin particles are dispersed in the aqueous solution (hereinafter will be referred to as “resin particle dispersion preparation step” in some cases), a step of adding and dispersing the inorganic particles in the resin particle dispersion (hereinafter will be referred to as “inorganic particle dispersing step” in some cases), and a step of mixing the organic amine compound, the tetracarboxylic dianhydride, and the diamine compound, and polymerizing the tetracarboxylic dianhydride and the diamine compound so as to form the polyimide precursor (hereinafter will be referred to as “polyimide precursor formation step” in some cases).

In the method for producing the polyimide precursor solution, to the solution in which the polyimide precursor is dissolved in the aqueous solution containing water in advance, the resin particles, and the inorganic particles (inorganic particles in a dry state or inorganic particles dispersed in the aqueous solution containing water) may be added so as to be dispersed.

The polyimide precursor solution of this exemplary embodiment is obtained in one system (for example, in one container) which is from the preparation of the resin particle dispersion to the preparation of the polyimide precursor solution, and therefore the step of producing the polyimide precursor solution is simplified. In addition, the polyimide precursor solution is handled without drying and taking out the resin particles, and therefore it possible to prevent the agglomerate from being generated when drying the resin particles. From the above viewpoint, for example, it is preferable that the polyimide precursor is formed in the particle dispersion in which the resin particles, and the inorganic particles are dispersed in the aqueous solution in advance.

Resin Particle Dispersion Preparation Step

As long as the resin particle dispersion in which the resin particles are dispersed in the aqueous solution is obtained, a method of the resin particle dispersion preparation step is not particularly limited.

Examples thereof include a method in which the resin particles that do not dissolve in the polyimide precursor solution, and the aqueous solution for the resin particle dispersion are weighed respectively, mixed, and stirred, and therefore the resin particle dispersion is obtained. The method in which the resin particles and the aqueous solution are mixed and stirred is not particularly limited. Examples thereof include a method in which the resin particles and the aqueous solution are mixed while stirring the aqueous solution, and the like. In addition, from the viewpoint of improving the dispersibility the resin particles, for example, at least one of an ionic surfactant or a nonionic surfactant may be mixed thereto.

Furthermore, the resin particle dispersion may be a resin particle dispersion obtained by granulating the resin particles in the aqueous solution. In the case of granulating the resin particles in the aqueous solution, a resin particle dispersion formed by polymerizing a monomer component in the aqueous solution may be produced. In this case, the resin particle dispersion may be a dispersion obtained by a known polymerization method. For example, in a case where the resin particles are vinyl resin particles, known polymerization methods (radical polymerization methods such as emulsion polymerization, soap-free emulsion polymerization, suspension polymerization, miniemulsion polymerization, and microemulsion polymerization) may be applied.

For example, in the case of applying the emulsion polymerization method to produce the vinyl resin particles, to water in which a water-soluble polymerization initiator such as potassium persulfate, or ammonium persulfate is dissolved, a monomer having a vinyl group such as styrenes or (meth)acrylic acids is added, and a surfactant such as sodium dodecyl sulfate or diphenyl oxide disulfonates is further added thereto as necessary, the polymerization is carried out by heating while stirring, and therefore the vinyl resin particles are obtained. Using a monomer having an acidic group as a monomer component, a vinyl resin having an acidic group on a surface thereof is obtained. In a case where the resin particle has an acidic group on the surface thereof, for example, it is preferable because the dispersibility of the resin particles is improved.

In the resin particle dispersion formation step, a method is not limited to the above-described method, and a commercially available resin particle dispersion in which the resin particles are dispersed in the aqueous solution may be prepared. In addition, in a case of using the commercially available resin particle dispersion, an operation such as dilution with the aqueous solution may be carried out depending on the purpose. Furthermore, within a range not affecting the dispersibility, in the dispersion in which the resin particles are dispersed in the organic solvent, the organic solvent may be replaced with an aqueous solution.

Inorganic Particle Dispersion Step

As long as a dispersion in which the inorganic particles are dispersed in the aqueous solution is obtained in the resin particle dispersion in which the resin particles are dispersed (that is, as long as a dispersion in which the resin particles and the inorganic particles are dispersed is obtained), a method of the inorganic particle dispersion step is not particularly limited.

In the inorganic particle dispersion step, the resin particle dispersion in which the resin particles are dispersed may be mixed with the inorganic particles of a dry state so as to obtain the dispersion in which the resin particles and the inorganic particles are dispersed. The resin particle dispersion in which the resin particles are dispersed may be mixed with the inorganic particle dispersion in which the inorganic particles are dispersed so as to obtain the dispersion in which the resin particles and the inorganic particles are dispersed. From the viewpoint of the dispersibility, for example, it is preferable that the resin particle dispersion in which the resin particles are dispersed is mixed with an aqueous solution dispersion of the inorganic particles so as to obtain the dispersion in which the resin particles and the inorganic particles are dispersed.

Polyimide Precursor Formation Step

Next, in the dispersion in which the resin particles and the inorganic particles are dispersed, for example, in the presence of the organic amine compound, tetracarboxylic dianhydride and a diamine compound are polymerized so as to generate a resin (polyimide precursor), and therefore the polyimide precursor solution is formed.

According to this method, since the aqueous solution is applied, productivity is high, and the polyimide precursor solution is produced in one step, which is, for example, preferable from the viewpoint of simplifying the steps.

Specifically, to the dispersion in which the resin particles and the inorganic particles are dispersed, which is prepared in the resin particle dispersion preparation step and the inorganic particle dispersion step, the organic amine compound, the tetracarboxylic dianhydride, and the diamine compound are mixed. Thereafter, in the presence of the organic amine compound, the tetracarboxylic dianhydride and the diamine compound are polymerized, and therefore the polyimide precursor is formed in the resin particle dispersion. An order of mixing the organic amine compound, the tetracarboxylic dianhydride, and the diamine compound in the resin particle dispersion is not particularly limited.

In the case where the tetracarboxylic dianhydride and the diamine compound are polymerized in the resin particle dispersion in which the resin particles and the inorganic particles are dispersed, the aqueous solution in the resin particle and inorganic particle dispersion may be used as it is so as to form the polyimide precursor. In addition, an aqueous solution may be newly mixed as necessary. In the case of newly mixing an aqueous solution, the aqueous solution may be an aqueous solution containing a small amount of an aprotic polar solvent. In addition, other additives may be mixed depending on the purpose.

According to the above-described steps, the polyimide precursor solution in which the resin particles, and the inorganic particle are dispersed is obtained (hereinafter will be referred to as “resin particle and inorganic particle-dispersed polyimide precursor solution” in some cases).

Next, materials constituting the resin particle and inorganic particle-dispersed polyimide precursor solution will be described.

Aqueous Solution Containing Water

In the regard to the aqueous solution, in the case where the tetracarboxylic dianhydride and the diamine compound are polymerized in the resin particle and inorganic particle dispersion, the resin particles, and the aqueous solution in the inorganic particle dispersion, which are used in the preparation of the resin particle and inorganic particle dispersion may be used as they are. In addition, in the case of polymerizing the tetracarboxylic dianhydride and the diamine compound, the aqueous solution may be prepared so as to be suitable for the polymerization.

The aqueous solution is the aqueous solution containing water. Specifically, the aqueous solution is not limited and is preferably a solvent in which water is contained by 50% by mass or more with respect to a total content of the aqueous solution. Examples of the water include distilled water, ion exchange water, ultrafiltered water, pure water, and the like.

A content of the water is, for example, preferably 50% by mass or more and 100% by mass or less, more preferably 70% by mass or more and 100% by mass or less, and even more preferably 80% by mass or more 100% by mass or less with respect to the entire aqueous solution.

The aqueous solution used in the case of preparing the resin particle dispersion is the aqueous solution containing the water. Specifically, the aqueous solution for the resin particle dispersion is not limited and is preferably the aqueous solution in which water is contained by 50% by mass or more with respect to the entire aqueous solution. Examples of the water include distilled water, ion exchange water, ultrafiltered water, pure water, and the like. In addition, in a case where a soluble organic solvent other than the water is contained, for example, a water-soluble alcohol solvent may be used. The term “water-soluble” means that a target substance is dissolved by 1% by mass or more with respect to the water at 25° C.

In the case where the aqueous solution contains the solvent other than the water, examples of the solvent other than water include the water-soluble organic solvent or the aprotic polar solvent. As the solvent other than the water, for example, the water-soluble organic solvent is preferable from the viewpoints of transparency, mechanical strength, and the like of the polyimide film. In particular, from the viewpoint of improving various properties of the polyimide film such as heat resistance, electrical properties, and solvent resistance in addition to the transparency and the mechanical strength, the aqueous solution may contain the aprotic polar solvent. In this case, for preventing dissolution and swelling of the resin particles in the resin particle and inorganic particle-dispersed polyimide precursor solution, a content of the solvent is, for example, preferably 40% by mass or less, and more preferably 30% by mass or less with respect to the entire aqueous solution. In addition, for preventing dissolution and swelling of the resin particles in the case of drying the polyimide precursor solution so as to make the film, for example, the solvent is preferably used by 5% by mass or more and 300% by mass or less, more preferably 5% by mass or more and 250% by mass or less, and even more preferably 5% by mass or more and 200% by mass or less with respect to a solid content of the polyimide precursor in the polyimide precursor solution. The term “water-soluble” means that a target substance is dissolved by 1% by mass or more with respect to the water at 25° C.

The water-soluble organic solvent may be used alone or in combination of two or more thereof.

As the water-soluble organic solvent, for example, a water-soluble organic solvent in which the resin particles do not dissolve is preferable, which is to be described below. The reason for this is because, for example, in a case where the aqueous solution containing the water and the water-soluble organic solvent is used, there is a concern that the resin particles dissolve during the process of producing the film even in a case where the resin particles do not dissolve in the resin particle dispersion, and therefore the water-soluble organic solvent may be used within a range capable of suppressing dissolution and swelling of the resin particles during the process of producing the film.

A water-soluble ether solvent is a water-soluble solvent having an ether bond in one molecule. Examples of the water-soluble ether solvent include tetrahydrofuran (THF), dioxane, trioxane, 1,2-dimethoxyethane, diethylene glycol dimethyl ether, diethylene glycol diethyl ether, and the like. Among these, for example, tetrahydrofuran and dioxane are preferable as the water-soluble ether solvent.

A water-soluble ketone solvent is a water-soluble solvent having a ketone group in one molecule. Examples of the water-soluble ketone solvent include acetone, methyl ethyl ketone, cyclohexanone, and the like. Among these, for example, acetone is preferable as the water-soluble ketone solvent.

A water-soluble alcohol solvent is a water-soluble solvent having an alcoholic hydroxyl group in one molecule. Examples of the water-soluble alcohol solvent include methanol, ethanol, 1-propanol, 2-propanol, tert-butyl alcohol, ethylene glycol, monoalkyl ether of ethylene glycol, propylene glycol, monoalkyl ether of propylene glycol, diethylene glycol, monoalkyl ether of diethylene glycol, 1,2-propanediol, 1,3-propanediol, 1,3-butanediol, 1,4-butanediol, 2,3-butanediol, 1,5-pentanediol, 2-butene-1,4-diol, 2-methyl-2,4-pentanediol, glycerin, 2-ethyl-2-hydroxymethyl-1,3-propanediol, 1,2,6-hexanetriol, and the like. Among these, as the water-soluble alcohol solvent, for example, methanol, ethanol, 2-propanol, ethylene glycol, monoalkyl ether of ethylene glycol, propylene glycol, monoalkyl ether of propylene glycol, diethylene glycol, monoalkyl ether of diethylene glycol are preferable.

In a case where the aprotic polar solvent other than water is contained as the aqueous solution, the aprotic polar solvent to be used in combination is a solvent having a boiling point of 150° C. or higher and 300° C. or lower and a dipole moment of 3.0 D or more and 5.0 D or less. Specific examples of the aprotic polar solvent include N-methyl-2-pyrrolidone (NMP), N,N-dimethylformamide (DMF), N,N-dimethylacetamide (DMAc), dimethylsulfoxide (DMSO), hexamethylenephosphoramide (HMPA), N-methylcaprolactam, N-acetyl-2-pyrrolidone, 1,3-dimethyl-2-imidazolidinone (DMI), N,N′-dimethylpropyleneurea, tetramethylurea, trimethyl phosphate, triethyl phosphate, and the like.

In the case where the solvent other than the water is contained as the aqueous solution, the solvent to be used in combination preferably has the boiling point of 270° C. or lower, more preferably 60° C. or higher and 250° C. or lower, and even more preferably 80° C. or higher and 230° C. or lower, for example. In the case where the boiling point of the solvent to be used in combination is within the above range, it becomes difficult for the solvent other than water to remain in the polyimide film, and the polyimide film having high mechanical strength is easily obtained.

A range in which the polyimide precursor dissolves in the solvent is controlled by a content of the water, a type and an amount of the organic amine compound. In a range in which the content of the water is small, the polyimide precursor is likely to dissolve in a region where a content of the organic amine compound is small. Conversely, in a range in which the content of the water is large, the polyimide precursor is likely to dissolve in a region where the content of the organic amine compound is large. In addition, in a case where the organic amine compound exhibits high hydrophilicity such as having a hydroxyl group, the polyimide precursor is likely to dissolve in a region where the content of the water is large.

Resin Particle

The resin particle is not particularly limited as long as the resin particle does not dissolve in the aqueous solution and does not dissolve in the polyimide precursor solution, and is a resin particle made of a resin other than polyimide. Examples thereof include a resin particle obtained by polycondensation of polymerizable monomers such as a polyester resin and a urethane resin, and a resin particle obtained by radical polymerization of polymerizable monomers such as a vinyl resin, an olefin resin, and a fluorine resin. Examples of the resin particle obtained by radical polymerization include a resin particle of a (meth)acrylic resin, a (meth)acrylic ester resin, a styrene-(meth)acrylic resin, a polystyrene resin, a polyethylene resin, and the like.

Among these, for example, it is preferable that the resin particle is at least one selected from the group consisting of a (meth)acrylic resin, a (meth)acrylic ester resin, a styrene-(meth)acrylic resin, and a polystyrene resin.

In this exemplary embodiment, the term “(meth)acrylic” means to include both “acrylic” and “methacrylic.”

In addition, the resin particles may be cross-linked or may not be cross-linked. In the step of imidizing the polyimide precursor, for example, the resin particles which are not cross-linked (resin particles having a non-crosslinked structure) are preferable in terms of effectively contributing to relaxation of the residual stresses. In addition, for example, the resin particle dispersion is more preferably a vinyl resin particle dispersion obtained by emulsion polymerization from the viewpoint of simplifying the steps of producing the resin particle-dispersed polyimide precursor solution.

In the case where the resin particles are the vinyl resin particles, the vinyl resin particles may be obtained by polymerizing monomers. Examples of the monomers of the vinyl resin include the following monomers. Examples thereof include vinyl resin units in which monomers are polymerized, such as styrenes having a styrene skeleton such as styrene, alkyl-substituted styrene (such as α-methylstyrene, 2-methylstyrene, 3-methylstyrene, 4-methylstyrene, 2-ethylstyrene, 3-ethylstyrene, and 4-ethylstyrene), halogen-substituted styrene (such as 2-chlorostyrene, 3-chlorostyrene, and 4-chlorostyrene), and vinyl naphthalene; esters having a vinyl group such as methyl (meth)acrylate, ethyl (meth)acrylate, n-propyl (meth)acrylate, n-butyl (meth)acrylate, lauryl (meth)acrylate, 2-ethylhexyl (meth)acrylate, and trimethylolpropane trimethacrylate (TMPTMA); vinyl nitriles such as acrylonitrile and methacrylonitrile; vinyl ethers such as vinyl methyl ether and vinyl isobutyl ether; vinyl ketones such as vinyl methyl ketone, vinyl ethyl ketone, and vinyl isopropenyl ketone; acids such as a (meth)acrylic acid, a maleic acid, a cinnamic acid, a fumaric acid, and a vinylsulfonic acid; bases such as ethyleneimine, vinylpyridine, and vinylamine; and the like.

As other monomers, a monofunctional monomer such as vinyl acetate, a bifunctional monomer such as ethylene glycol dimethacrylate, nonanediacrylate, and decanediol diacrylate, and a polyfunctional monomer such as trimethylolpropane triacrylate and trimethylolpropane trimethacrylate may be used in combination.

In addition, the vinyl resin may be a resin using these monomers alone, or may be a resin that is a copolymer using two or more of the monomers.

For example, the resin particle preferably has an acidic group on the surface thereof from the viewpoint of improving the dispersibility. It is considered that the acidic group present on the surface of the resin particle functions as a dispersant for the resin particles by forming abase and a salt of the organic amine compound and the like used for dissolving the polyimide precursor in the aqueous solution. Therefore, it is considered that the dispersibility of the resin particles in the polyimide precursor solution is improved.

The acidic group present on the surface of the resin particle is not particularly limited, but may be at least one selected from the group consisting of a carboxy group, a sulfonic acid group, and a phenolic hydroxyl group. Among these, for example, the carboxy group is preferable.

The monomer that allows the acidic group to be provided on the surface of the resin particles is not particularly limited as long as the monomer is a monomer having the acidic group. Examples thereof include a monomer having a carboxy group, a monomer having a sulfonic acid group, a monomer having a phenolic hydroxyl group, and salts thereof.

Specific examples thereof include a monomer having a sulfonic acid group such as a p-styrene sulfonic acid and a 4-vinylbenzene sulfonic acid; a monomer having a phenolic hydroxyl group such as a 4-vinyldihydro-cinnamic acid, and 4-vinylphenol, 4-hydroxy-3-methoxy-1-propenylbenzene; a monomer having a carboxy group such as an acrylic acid, a crotonic acid, a methacrylic acid, a 3-methylcrotonic acid, a fumaric acid, a maleic acid, a 2-methylisocrotonic acid, a 2,4-hexadiene diacid, a 2-pentenoic acid, a sorbic acid, a citraconic acid, a 2-hexenoic acid, and a monoethyl fumarate; and salts thereof. These monomers having the acidic group may be mixed with a monomer not having the acidic group and polymerized, or a monomer not having the acidic group may be polymerized and particulated, and then the monomer having the acidic group on the surface of the monomer may be polymerized. In addition, these monomers may be used alone or in combination of two or more kinds thereof.

Among these, for example, a monomer having a carboxy group such as an acrylic acid, a crotonic acid, a methacrylic acid, a 3-methylcrotonic acid, a fumaric acid, a maleic acid, a 2-methylisocrotonic acid, a 2,4-hexadiene diacid, a 2-pentenoic acid, a sorbic acid, a citraconic acid, a 2-hexenoic acid, and a monoethyl fumarate, and salts thereof, is preferable. The monomer having a carboxy group may be used alone or in combination of two or more kinds thereof.

That is, for example, it is preferable that the resin particle having the acidic group on the surface thereof has a skeleton derived from the monomer having at least one carboxy group selected from the group consisting of an acrylic acid, a crotonic acid, a methacrylic acid, a 3-methylcrotonic acid, a fumaric acid, a maleic acid, a 2-methylisocrotonic acid, a 2,4-hexadiene diacid, a 2-pentenoic acid, a sorbic acid, a citraconic acid, a 2-hexenoic acid, and a monoethyl fumarate, and salts thereof.

In the case where the monomer having the acidic group and the monomer not having the acidic group are mixed and polymerized, an amount of the monomer having the acidic group is not particularly limited, but in a case where the amount of the monomer having the acidic group is excessively small, the dispersibility of the resin particles in the polyimide precursor solution deteriorates in some cases, whereas in a case where the amount of the monomer having the acidic group is excessively large, an aggregate of a polymer is generated in some cases when performing the emulsion polymerization. Therefore, an amount of the monomer having the acidic group is, for example, preferably 0.3% by mass or more and 20% by mass or less, more preferably 0.5% by mass or more and 15% by mass or less, and particularly preferably 0.7% by mass or more and 10% by mass or less with respect to a total amount of the monomers.

Meanwhile, in the case where the monomer not having the acidic group is subjected to the emulsion polymerization, and then the monomer having the acidic group is added thereto and polymerized, from the same viewpoint described above, the amount of the monomer having the acidic group is, for example, preferably 0.01% by mass or more and 10% by mass or less, more preferably 0.05% by mass or more and 7% by mass or less, and particularly preferably 0.07% by mass or more and 5% by mass or less with respect to the total amount of the monomers.

As described above, for example, it is preferable that the resin particles are not cross-linked, but when the resin particles are cross-linked, in a case of using a cross-linking agent as at least a part of monomer components, a percentage of the cross-linking agent accounting for total monomer components is, for example, preferably 0% by mass or more and 20% by mass or less, more preferably 0% by mass or more and 5% by mass or less, and particularly preferably 0% by mass.

In a case where the monomer used for the resin constituting the vinyl resin particles contains styrene, a percentage of styrene accounting for the total monomer components is, for example, preferably 20% by mass or more and 100% by mass or less, and more preferably 40% by mass or more and 100% by mass or less.

An average particle diameter of the resin particles is not particularly limited. For example, the average particle diameter is preferably 0.01 μm or larger and 5 μm and smaller, and more preferably 0.02 μm or larger and 4 μm or smaller, and even more preferably 0.25 μm or larger and 3 μm or smaller. In the case where the average particle diameter of the resin particles is within the above range, the productivity of the resin particles is improved, and thus the suppression of aggregating properties becomes easy. Furthermore, the increase in the relative dielectric constant of the porous polyimide film is suppressed, and the heat conductivity is easily improved.

As the average particle diameter of the resin particles, a particle size distribution obtained by measurement with a laser diffraction type particle size distribution measuring apparatus (for example, COULTER COUNTER LS13 described above, manufactured by Beckman Coulter, Inc.) is used, a cumulative distribution is subtracted from a divided particle size range (channel), from a smaller particle diameter in the volume, and a particle diameter accumulating 50% of all the particles is measured as a volume average particle diameter D50v.

The resin particles may be particles obtained by polymerizing the monomers having the acidic group on the surface of commercially available products. Specific examples of the cross-linked resin particles include cross-linked polymethyl methacrylate (MBX-series, manufactured by Sekisui Plastics Co., Ltd.), cross-linked polystyrene (SBX-series, manufactured by Sekisui Plastics Co., Ltd.), copolymerized cross-linked resin particles of methyl methacrylate and styrene (MSX-series, manufactured by Sekisui Plastics Co., Ltd.), and the like.

In addition, examples of the non-crosslinked resin particles include polymethyl methacrylate (MB-series, manufactured by Sekisui Plastics Co., Ltd.), (meth)acrylic ester-styrene copolymer (FS-series, manufactured by Nippon Paint Co., Ltd.), and the like.

In the polyimide precursor solution, a content of the resin particles is, for example, preferably within a range of 20 parts by mass to 600 parts by mass (for example, more preferably 25 parts by mass or more and 550 parts by mass or less, and even more preferably 30 parts by mass or more and 500 parts by mass or less) with respect to 100 parts by mass of solid contents of the polyimide precursor in the polyimide precursor solution.

Inorganic Particle

The inorganic particles are not particularly limited, but preferably inorganic particles having the heat conductivity. Among these, the inorganic particle is, for example, preferably at least one selected from the group consisting of a metal nitride, a metal carbide, and a metal oxide, from the viewpoints of suppressing an increase in the relative dielectric constant of the porous polyimide film and ease of improvement in the heat conductivity. The inorganic particle having the heat conductivity means an inorganic particle having a heat conductivity of 1 W/(m·K) or more.

In regard to the heat conductivity and the relative dielectric constant of the inorganic particle, for example, in a case where the inorganic particle is a metal nitride, examples thereof include boron nitride (heat conductivity: about 60 W/(m·K), relative dielectric constant: about 3.9), and silicon nitride (heat conductivity: about 50 W/(m·K), relative dielectric constant: about 8.3). In addition, in a case where the inorganic particle is, for example, a metal carbide, examples thereof include silicon carbide (heat conductivity: about 270 W/(m·K), relative dielectric constant: about 27). Furthermore, in a case where the inorganic particle is, for example, a metal oxide, examples thereof include aluminum oxide (heat conductivity: about 30 W/(m·K), relative dielectric constant: about 8.5), magnesium oxide (heat conductivity: about 40 W/(m·K), relative dielectric constant: about 9.8), and zinc oxide (heat conductivity: about 25 W/(m·K), relative dielectric constant: about 8.3).

Among the metal nitrides, metal carbides, and metal oxides, the inorganic particle is, for example, more preferably at least one selected from the group consisting of boron nitride, silicon nitride, aluminum nitride, silicon carbide, aluminum oxide, magnesium oxide, zinc oxide, and beryllium oxide, and even more preferably at least one selected from the group consisting of boron nitride, silicon nitride, silicon carbide, aluminum oxide, magnesium oxide, and zinc oxide. In addition, from the viewpoints of the heat conductivity, electric conductivity, and specific gravity, the inorganic particle is, for example, particularly preferably at least one selected from the group consisting of boron nitride, silicon nitride, aluminum nitride, aluminum oxide, and magnesium oxide. Among these, for example, boron nitride is most preferable from the viewpoints of a weight and a dielectric constant when being formed into a molded article. As these inorganic particles, for example, a known particle described in a heat dissipation filler catalog for electric materials (SHOWA DENKO K.K.) may be used. These inorganic particles may be used alone or in combination of two or more kinds thereof.

A volume average particle diameter of the inorganic particles is, for example, preferably 0.1 μm or larger and 30 μm or smaller from the viewpoints of dispersion stability of the inorganic particles in the solution and excellent dispersibility even in the porous polyimide film. From the same viewpoints, the average particle diameter of the inorganic particles is, for example, preferably 0.2 μm or larger and 25 μm or smaller, more preferably 0.25 μm or larger and 25 μm or smaller, and even more preferably 0.4 μm or larger and 20 μm or smaller.

The volume average particle diameter of the inorganic particles is measured by the same method of the above-described method for measuring the volume average particle diameter of the resin particles.

The inorganic particles may have a shape close to a spherical shape or may not have a spherical shape. In a case where the inorganic particles are not spherical, an aspect ratio of the inorganic particles may be 3 or more and 200 or less. The aspect ratio of the inorganic particles means an average value of a ratio of a major axis/a minor axis in a case where the shape of the inorganic particles is approximately an ellipsoid. The approximately ellipsoid means an ellipsoid having a volume center of gravity and having a smallest volume capable of including the inorganic particles.

The aspect ratio of the inorganic particles is measured by, for example, the following method. Using a scanning electron microscope, photographs are captured at a magnification at which the inorganic particles may be measured (for example, 300 times or more and 100000 times or less), and in a state where an obtained image of the inorganic particles is two-dimensionally formed, a major axis and a minor axis are measured, and an aspect ratio is calculated.

In the polyimide precursor solution, a content of the inorganic particles is not particularly limited because the heat conductivity and the relative dielectric constant to be obtained change depending on the type of the inorganic particles. For example, from the viewpoints of suppressing an increase in the relative dielectric constant of the porous polyimide film and easily improving the heat conductivity, the content of the inorganic particles is, for example, preferably 10 parts by mass or more and 300 parts by mass or less, more preferably within a range of 15 parts by mass to 200 parts by mass, and even more preferably within a range of 20 parts by mass to 150 parts by mass with respect to 100 parts by mass of the polyimide precursor in the polyimide precursor solution.

In the polyimide precursor solution, although there is no particular limitation, for example, it is preferable that a volume ratio between the resin particles and the inorganic particles satisfies the following relationship, from the viewpoints of suppressing an increase in the relative dielectric constant of the porous polyimide film and easily improving the heat conductivity.

When the relative dielectric constant of the inorganic particles is εi and the volume ratio of the inorganic particles and the resin particles is Vr 1, it is preferable that a relationship between the relative dielectric constant εi and the volume ratio Vr 1 satisfies Formula 1, for example, although there is no particular limitation.

Vr1>εi−3.4 Formula 1

(Vr 1 is a value represented by a volume (Vp) of the resin particle/a volume (Vi) of the inorganic particle)

Furthermore, although there is no particular limitation, for example, it is more preferable that Formula 1 satisfies a relationship of Vr 1>εi−3.2, and it is even more preferable that Formula 1 satisfies a relationship of Vr 1>εi−3.0.

Polyimide Precursor

The polyimide precursor is obtained by the polymerization of tetracarboxylic dianhydride and a diamine compound. Specifically, the polyimide precursor is a resin (polyamic acid) having a repeating unit represented by General Formula (I).

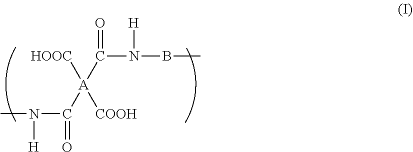

In General Formula (I), A represents a tetravalent organic group, and B represents a divalent organic group.

In General Formula (I), the tetravalent organic group represented by A is a residue of the tetracarboxylic dianhydride as a raw material, from which four carboxy groups are removed.

Meanwhile, the divalent organic group represented by B is a residue of the diamine compound as a raw material, from which two amino groups are removed.

That is, the polyimide precursor having the repeating unit represented by General Formula (I) is a polymer of the tetracarboxylic dianhydride and the diamine compound.

Examples of the tetracarboxylic dianhydride include any compound of aromatic and aliphatic compounds, but the aromatic compound is preferable, although there is no particular limitation. That is, in General Formula (I), the tetravalent organic group represented by A is not limited and is preferably an aromatic organic group.

Examples of the aromatic tetracarboxylic dianhydride include pyromellitic dianhydride, 3,3′,4,4′-benzophenone tetracarboxylic dianhydride, 3,3′,4,4′-biphenylsulfone tetracarboxylic dianhydride, 1,4,5,8-naphthalene tetracarboxylic dianhydride, 2,3,6,7-naphthalene tetracarboxylic dianhydride, 3,3′,4,4′-biphenyl ether tetracarboxylic dianhydride, 3,3′,4,4′-dimethyldiphenylsilane tetracarboxylic dianhydride, 3,3′,4,4′-tetraphenylsilane tetracarboxylic dianhydride, 1,2,3,4-furan tetracarboxylic dianhydride, 4,4′-bis (3,4-dicarboxyphenoxy) diphenyl sulfide dianhydride, 4,4′-bis (3,4-dicarboxyphenoxy) diphenyl sulfone dianhydride, 4,4′-bis(3,4-dicarboxyphenoxy)diphenylpropane dianhydride, 3,3′,4,4′-perfluoroisopropylidene diphthalic dianhydride, 3,3′,4,4′-biphenyltetracarboxylic dianhydride, 2,3,3′,4′-biphenyltetracarboxylic dianhydride, bis(phthalic acid)phenyl phosphine oxide dianhydride, p-phenylene-bis(triphenylphthalic acid) dianhydride, m-phenylene-bis(triphenylphthalic acid) dianhydride, bis(triphenylphthalic acid)-4,4′-diphenyl ether dianhydride, bis(triphenylphthalic acid)-4,4′-diphenylmethane dianhydride, and the like.

Examples of the aliphatic tetracarboxylic dianhydride include aliphatic or alicyclic tetracarboxylic dianhydride such as butane tetracarboxylic dianhydride, 1,2,3,4-cyclobutane tetracarboxylic dianhydride, 1,3-dimethyl-1,2,3,4-cyclobutane tetracarboxylic dianhydride, 1,2,3,4-cyclopentane tetracarboxylic dianhydride, 2,3,5-tricarboxycyclopentyl acetic dianhydride, 3,5,6-tricarboxynorbornane-2-acetic dianhydride, 2,3,4,5-tetrahydrofuran tetracarboxylic dianhydride, 5-(2,5-dioxotetrahydrofuryl)-3-methyl-3-cyclohexene-1,2-di carboxylic dianhydride, and bicyclo[2,2,2]-oct-7-ene-2,3,5,6-tetracarboxylic dianhydride; an aliphatic tetracarboxylic dianhydride having an aromatic ring such as 1,3,3a,4,5,9b-hexahydro-(2,5-dioxo-3-furanyl)-naphtho[1,2-c]furan-1,3-dione, 1,3,3a,4,5,9b-hexahydro-5-methyl-5-(tetrahydro-2,5-dioxo-3-furanyl)-naphtho[1,2-c]furan-1,3-dione, and 1,3,3a,4,5,9b-hexahydro-8-methyl-5-(tetrahydro-2,5-dioxo-3-furanyl)-naphtho[1,2-c]furan-1,3-dione; and the like.

Among these, as the tetracarboxylic dianhydride, although there is no particular limitation, the aromatic tetracarboxylic dianhydride is preferable, and specific examples are more preferably pyromellitic dianhydride, 3,3′,4,4′-biphenyl tetracarboxylic dianhydride, 2,3,3′,4′-biphenyl tetracarboxylic dianhydride, 3,3′,4,4′-biphenyl ether tetracarboxylic dianhydride, and 3,3′,4,4′-benzophenone tetracarboxylic dianhydride, more preferably pyromellitic dianhydride, 3,3′,4,4′-biphenyl tetracarboxylic dianhydride, and 3,3′,4,4′-benzophenone tetracarboxylic dianhydride, and particularly preferably 3,3′,4,4′-biphenyl tetracarboxylic dianhydride.

The tetracarboxylic dianhydride may be used alone or in combination of two or more thereof.

In addition, in a case of the combination of two or more thereof, each of an aromatic tetracarboxylic dianhydride or an aliphatic tetracarboxylic acid may be used in combination, or the aromatic tetracarboxylic dianhydride and the aliphatic tetracarboxylic dianhydride may be combined to be used.

Meanwhile, the diamine compound is a diamine compound having two amino groups in a molecule structure. Examples of the diamine compound include any compound of aromatic and aliphatic compounds, but the aromatic compound is preferable, although there is no particular limitation. That is, in General Formula (I), the divalent organic group represented by B is not limited and is preferably an aromatic organic group.

Examples of the diamine compound include aromatic diamines such as p-phenylenediamine, m-phenylenediamine, 4,4′-diaminodiphenylmethane, 4,4′-diaminodiphenylethane, 4,4′-diaminodiphenyl ether, 4,4′-diaminodiphenyl sulfide, 4,4′-diaminodiphenyl sulfone, 1,5-diaminonaphthalene, 3,3-dimethyl-4,4′-diaminobiphenyl, 5-amino-1-(4′-aminophenyl)-1,3,3-trimethylindane, 6-amino-1-(4′-aminophenyl)-1,3,3-trimethylindane, 4,4′-diaminobenzanilide, 3,5-diamino-3′-trifluoromethylbenzanilide, 3,5-diamino-4′-trifluoromethylbenzanilide, 3,4′-diaminodiphenyl ether, 2,7-diaminofluorene, 2,2-bis(4-aminophenyl)hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2-bis[4-(4-aminophenoxy)phenyl] propane, 2,2-bis[4-(4-aminophenoxy)phenyl] hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl)fluorene, 4,4′-(p-phenyleneisopropylidene)bisaniline, 4,4′-(m-phenyleneisopropylidene)bisaniline, 2,2′-bis[4-(4-amino-2-trifluoromethylphenoxy)phenyl] hexafluoropropane, and 4,4′-bis[4-(4-amino-2-trifluoromethyl)phenoxy]-octafluorobiphenyl; an aromatic diamine having two amino groups bonded to an aromatic ring such as diaminotetraphenylthiophene and a hetero atom other than the nitrogen atom of the amino group; aliphatic diamines and alicyclic diamines such as 1,1-meta-xylylene diamine, 1,3-propane diamine, tetramethylene diamine, pentamethylene diamine, octamethylene diamine, nonamethylene diamine, 4,4-diaminoheptamethylene diamine, 1,4-diaminocyclohexane, isophorone diamine, tetrahydrodicyclopentadienylenediamine, hexahydro-4,7-methanoindanylenedimethylene diamine, tricyclo[6,2,1,0^{2.7}]-undecylenedimethyldiamine, and 4,4′-methylenebis(cyclohexylamine); and the like.

Among these, as the diamine compound, the aromatic diamine compound is, for example, preferable, and specific examples thereof are more preferably p-phenylenediamine, m-phenylenediamine, 4,4′-diaminodiphenylmethane, 4,4′-diaminodiphenyl ether, 3,4′-diaminodiphenyl ether, 4,4′-diaminodiphenyl sulfide, and 4,4′-diaminodiphenyl sulfone, and particularly preferably 4,4′-diaminodiphenyl ether and p-phenylenediamine.

The diamine compound may be used alone or in combination of two or more thereof. In addition, in a case of the combination of two or more thereof, each of the aromatic diamine compound and the aliphatic diamine compound may be used in combination, or the aromatic diamine compound and the aliphatic diamine compound may be combined to be used.

A number-based average molecular weight of the polyimide precursor is, for example, preferably 1000 or more and 150000 or less, more preferably 5000 or more and 130000 or less, and even more preferably 10000 or more and 100000 or less.

In a case where the number-based average molecular weight of the polyimide precursor is within the above range, a deterioration in the solubility of the polyimide precursor in the solvent is suppressed, and thus a film forming property is easily ensured.

The number-based average molecular weight of the polyimide precursor is measured by a gel permeation chromatography (GPC) method under following measurement conditions.
Column: TSKgel α-M of Tosoh Corporation (7.8 mm I.D×30 cm)
Eluent: DMF (dimethylformamide)/30 mM LiBr/60 mM phosphoric acid
Flow rate: 0.6 mL/min
Injection volume: 60 μL
Detector: RI (differential refractive index detector)

A content (concentration) of the polyimide precursor is, for example, preferably 0.1% by mass or more and 40% by mass or less, and more preferably 0.5% by mass or more and 25% by mass or less, and even more preferably 1% by mass or more and 20% by mass or less with respect to a total content of the polyimide precursor solution.

Organic Amine Compound

The organic amine compound is a compound which amine-salifies the polyimide precursor (a carboxy group thereof) to improve the solubility of the polyimide precursor in the aqueous solution, and which also function as an imidization promoter. Specifically, for example, the organic amine compound is not limited and is preferably an amine compound having a molecular weight of 170 or less. The organic amine compound is not limited and is preferably a compound excluding a diamine compound which is a raw material of the polyimide precursor.

The organic amine compound is not limited and is preferably a water-soluble compound. The term “water-soluble” means that a target substance is dissolved by 1% by mass or more with respect to the water at 25° C.

Examples of the organic amine compound include a primary amine compound, a secondary amine compound, and a tertiary amine compound.

Among these, as the organic amine compound, at least one (particularly, tertiary amine compound) selected from the secondary amine compound and the tertiary amine compound is preferable although there is no particular limitation. In a case of applying the tertiary amine compound or the secondary amine compound as the organic amine compound (particularly, the tertiary amine compound), the solubility of the polyimide precursor in the solvent is easily improved, a film forming property is easily improved, and preservation stability of the polyimide precursor solution is easily improved.

In addition, examples of the organic amine compound include a divalent or higher polyvalent amine compound, in addition to a monovalent amine compound. In a case of applying the divalent or higher polyvalent amine compound, a pseudo-crosslinked structure between molecules of the polyimide precursor is easily formed, and the preservation stability of the polyimide precursor solution is easily improved.

Examples of the primary amine compound include methylamine, ethylamine, n-propylamine, isopropylamine, 2-ethanolamine, 2-amino-2-methyl-1-propanol, and the like.

Examples of the secondary amine compound include dimethylamine, 2-(methylamino) ethanol, 2-(ethylamino) ethanol, morpholine, and the like.

Examples of the tertiary amine compound include 2-dimethylaminoethanol, 2-diethylaminoethanol, 2-dimethylaminopropanol, pyridine, triethylamine, picoline, N-methylmorpholine, N-ethylmorpholine, 1,2-dimethylimidazole, 2-ethyl-4-methylimidazole, and the like.

From the viewpoints of a pot life of the polyimide precursor solution and film thickness evenness, for example, the tertiary amine compound is preferable. From the above viewpoints, at least one selected from the group consisting of 2-dimethylaminoethanol, 2-diethylaminoethanol, 2-dimethylaminopropanol, pyridine, triethylamine, picoline, N-methylmorpholine, N-ethylmorpholine, 1,2-dimethylimidazole, 2-ethyl-4-methylimidazole, N-methylpiperidine, and N-ethylpiperidine is, for example, more preferable.

As the organic amine compound, for example, from the viewpoint of the film forming property, an amine compound having a nitrogen-containing heterocyclic structure (particularly, the tertiary amine compound) is also preferable. Examples of the amine compound having a nitrogen-containing heterocyclic structure (hereinafter will be referred to as “nitrogen-containing heterocyclic amine compound”) include isoquinolines (amine compounds having an isoquinoline skeleton), pyridines (amine compounds having a pyridine skeleton), pyrimidines (amine compounds having a pyrimidine skeleton), pyrazines (amine compounds having a pyrazine skeleton), piperazines (amine compounds having a piperazine skeleton), triazines (amine compounds having a triazine skeleton), imidazoles (amine compounds having an imidazole skeleton), morpholines (amine compounds having a morpholine skeleton), polyaniline, polypyridine, polyamine, and the like.

As the nitrogen-containing heterocyclic amine compound, from the viewpoint of the film forming property, for example, at least one selected from the group consisting of morpholines, pyridines, piperidines, and imidazoles is preferable, and morpholines (amine compounds having a morpholine skeleton) is more preferable. Among these, for example, at least one selected from the group consisting of N-methylmorpholine, N-methylpiperidine, pyridine, 1,2-dimethylimidazole, 2-ethyl-4-methylimidazole, and picoline is more preferable, and N-methylmorpholine is even more preferable.

Among these, as the organic amine compound, for example, a compound having a boiling point of 60° C. or higher (for example, preferably 60° C. or higher and 200° C. or lower, more preferably 70° C. or higher and 150° C. or lower) is preferable. In a case where the organic amine compound has the boiling point of 60° C. or higher, volatilization of the organic amine compound from the polyimide precursor solution when storing the compound is suppressed, and a deterioration in the solubility of the polyimide precursor in the solvent is easily suppressed.

A content of the organic amine compound is, for example, preferably 50 mol % or more and 500 mol % or less, more preferably 80 mol % or more and 250 mol % or less, and even more preferably 90 mol % or more and 200 mol % or less with respect to a carboxy group (—COOH) of the polyimide precursor in the polyimide precursor solution.

In a case where the content of the organic amine compound is within the above range, the solubility of the polyimide precursor in the solvent is easily improved, and thus the film forming property is easily improved. In addition, the preservation stability of the polyimide precursor solution is also easily improved.

The organic amine compound may be used alone or in combination of two or more thereof.

Other Additives

In the method for producing the polyimide precursor solution according to this exemplary embodiment, the polyimide precursor solution may contain a catalyst for accelerating imidization reaction, a leveling agent for improving a quality of a film to be formed, and the like.

As the catalyst for accelerating the imidization reaction, a dehydrating agent such as an acid anhydride, an acid catalyst such as a phenol derivative, a sulfonic acid derivative, and a benzoic acid derivative, or the like may be used.

Polyimide Film Containing Resin Particles and Inorganic Particles

The polyimide film containing the resin particles and the inorganic particles is obtained by applying the polyimide precursor solution according to this exemplary embodiment so as to form a coated film, and then heating the coated film.

The polyimide film containing the resin particles and the inorganic particles includes a polyimide film that contains the resin particles and the inorganic particles and that is partially imidized before completing of the imidization, in addition to a polyimide film that contains the resin particles and the inorganic particles and in which the imidization is completed.

Specifically, the method for producing the polyimide film containing the resin particles and the inorganic particles according to this exemplary embodiment includes, for example, a step of applying the polyimide precursor solution according to this exemplary embodiment to form a coated film (hereafter will be referred to as “coated film formation step”), and a step of heating the coated film to form the polyimide film (hereafter will be referred to as “heating step”).

Coated Film Formation Step

First, the above-described polyimide precursor solution in which the resin particles are dispersed (resin particle and inorganic particle-dispersed polyimide precursor solution) is prepared. Subsequently, the resin particle and inorganic particle-dispersed polyimide precursor solution is applied on the substrate, and therefore the coated film is formed.

Examples of the substrate include a substrate made of resin; a substrate made of glass; a substrate made of ceramic; a metal substrate; and a substrate of a composite material obtained by combining these materials. The substrate may have a peeling layer which has been subjected to a peeling process.

In addition, a method for applying the resin particle and inorganic particle-dispersed polyimide precursor solution to the substrate is not particularly limited, and examples thereof include various methods such as a spray coating method, a spin coating method, a roll coating method, a bar coating method, a slit die coating method, and an ink jet coating method.

As the substrate, various substrates may be used according to a purpose of use. Examples thereof include various substrates applied to liquid crystal elements; a semiconductor substrate on which an integrated circuit is formed, a wiring substrate on which wiring is formed, and a print substrate provided with electronic parts and wiring; a substrate for electric wire; and the like.

Heating Step

Next, the coated film obtained in the coated film formation step is subjected to a drying process. In the drying process, a dried coated film (dried coat before imidization) is formed.

As a heating condition in the drying process, for example, heating at a temperature of 80° C. or higher and 200° C. or lower for 10 minutes or longer and 60 minutes or shorter, is preferable, and it is more preferable that a heating time becomes shorter as a temperature becomes higher. Applying hot air during the heating is also effective. When heating, the temperature may be raised step by step, or may be raised without changing a raising speed.

Next, the dried coated film before being subject to the imidization is heated, and the imidization process is performed. Therefore, a polyimide resin layer is formed.

As a heating condition in the imidization process, an imidization reaction is raised by heating at, for example, 150° C. or higher and 450° C. or lower (for example, preferably 200° C. or higher and 430° C. or lower) for 20 minutes or longer and 60 minutes or shorter, and therefore the polyimide film is formed. In a case of the heating reaction, for example, it is preferably that before the temperature reaches a final temperature for the heating, the heating is performed by raising the temperature step by step, or gradually raising the temperature at a certain speed.

Through the above-described steps, the polyimide film containing the resin particles and the inorganic particles is formed. Then, as necessary, the polyimide film containing the resin particles and the inorganic particles is taken out from the substrate, and the polyimide film containing the resin particles and the inorganic particles is obtained. In addition, the polyimide film containing the resin particles and the inorganic particles may be subjected to a post process according to a purpose of use.

Method for Producing Porous Polyimide Film

A method for producing the porous polyimide film according to this exemplary embodiment includes a first step of applying the polyimide precursor solution according to this exemplary embodiment to form a coated film, and then drying the coated film so as to form a dried coated film containing the polyimide precursor, the resin particles, and the inorganic particles; and a second step of heating the dried coated film and imidizing the polyimide precursor so as to form a polyimide film, the second step having a process of removing the resin particles.

Hereinafter, the method for producing the porous polyimide film according to this exemplary embodiment will be described.

First Step

In a first step, first, the polyimide precursor solution containing the aqueous solution, the resin particles, and the inorganic particles (resin particle and inorganic particle-dispersed polyimide precursor solution) is prepared. Subsequently, the resin particle and inorganic particle-dispersed polyimide precursor solution is applied to the substrate, and therefore the coated film containing the polyimide precursor solution, the resin particles, and the inorganic particles is formed. Then, the coated film formed on the substrate dried, and therefore the dried coated film containing the polyimide precursor, the resin particles, and the inorganic particles is formed.

In the first step, examples of a method for forming, on the substrate, the coated film containing the polyimide precursor, the resin particles, and the inorganic particles include a method as follows, but the method is not limited to the following method.

Specifically, first, the dispersion in which the resin particles and the inorganic particles are dispersed in the aqueous solution is prepared. Then, the organic amine compound, the tetracarboxylic dianhydride, and the diamine compound are mixed in this dispersion, the tetracarboxylic dianhydride and the diamine compound are polymerized, and therefore the polyimide precursor is formed. Subsequently, this resin particle and inorganic particle-dispersed polyimide precursor solution is applied to the substrate, and therefore the coated film containing the polyimide precursor solution, the resin particles, and the inorganic particles is formed. The resin particles and the inorganic particles in this coated film are distributed in a state in which aggregation is suppressed.

The substrate to which the resin particle and inorganic particle-dispersed polyimide precursor solution is applied is not particularly limited. Examples thereof include a resin substrate made of polystyrene, polyethylene terephthalate, or the like; a glass substrate; a ceramic substrate; a metal substrate such as iron, copper, aluminum, and stainless steel (SUS); a composite material substrate obtained by combining these materials; and the like. In addition, as necessary, the substrate may have a peeling layer subjected to the peeling process by, for example, a silicone-based or fluorine-based peeling agent or the like.

A method for applying, to the substrate, the resin particle and inorganic particle-dispersed polyimide precursor solution is not particularly limited. Examples thereof include various methods such as a spray coating method, a spin coating method, a roll coating method, a bar coating method, a slit die coating method, and an ink jet coating method.

An amount to be applied of the polyimide precursor solution for obtaining the coated film containing the polyimide precursor solution, the resin particles, and the inorganic particles may be set to an amount by which a predetermined film thickness is obtained.

The coated film containing the polyimide precursor solution, the resin particles, and the inorganic particles is formed and then dried, and therefore the dried coated film containing the polyimide precursor, the resin particles, and the inorganic particles is formed. Specifically, the coated film containing the polyimide precursor solution, the resin particles, and the inorganic particles is dried by a method such as heat drying, natural drying, and vacuum drying, and therefore the dried coated film is formed. More specifically, the coated film is dried such that a content of the solvent remaining in the coat becomes 50% or less, and becomes, for example, preferably 30% or less with respect to a solid content of the coat, and therefore the dried coated film is formed. The dried coated film is in a state where the polyimide precursor may be dissolved in water.

Second Step

A second step is a step of heating the dried coated film containing the polyimide precursor, the resin particles, and the inorganic particles, which is obtained in the first step, imidizing the polyimide precursor so as to form the polyimide film. Then, the second step includes the process for removing the resin particles. Through the process for removing the resin particles, the porous polyimide film is obtained.

In the second step, in the step of forming the polyimide film, specifically, the dried coated film containing the polyimide precursor, the resin particles, and the inorganic particles, which is obtained in the first step is heated, the imidization is allowed to proceed, and by further heating, the polyimide film is formed. As the imidization proceeds and a rate of the imidization becomes higher, the polyimide precursor becomes unlikely to be dissolved in the organic solvent.

Then, in the second step, the process of removing the resin particles is performed. The resin particles may be removed during the process of imidizing the polyimide precursor by heating the dried coated film, or may be removed from the polyimide film in which the imidization is completed (after the imidization).

In this exemplary embodiment, the process of imidizing the polyimide precursor refers to a process in which the dried coated film containing the polyimide precursor and the resin particles, which is obtained in the first step is heated, the imidization is allowed to proceed, and the polyimide film becomes in a state before completing the imidization.

The process of removing the resin particles is, for example, preferably carried out when the imidization ratio of the polyimide precursor in the polyimide film becomes 10% or more in the process of imidizing the polyimide precursor, from the viewpoint of removing performance of the resin particles and the like. In the case where the imidization ratio becomes 10% or more, the polyimide precursor easily becomes in the state of being unlikely to be dissolved in the organic solvent, and therefore a form of the film is easily maintained.

Examples of the process of removing the resin particles include a method of removing the resin particles by heating, a method of removing the resin particles by the organic solvent in which the resin particles are dissolved, a method of removing the resin particles by decomposition by a laser and the like, and the like. Among these, for example, the method of removing the resin particles by heating and the method of removing the resin particles by the organic solvent in which the resin particles are dissolved are preferable.

In the method of removing the resin particles by heating, for example, in the process of imidizing the polyimide precursor, the resin particles may be removed by decomposition by heating which is for allowing the imidization to proceed.

The organic solvent for dissolving the resin particles, which is for removing the resin particles is not particularly limited as long as the organic solvent is an organic solvent in which the resin particles are soluble without dissolving the polyimide film and the polyimide film in which the imidization is completed. Examples thereof include ethers such as tetrahydrofuran; aromatics such as toluene; ketones such as acetone; and esters such as ethyl acetate.

In the second step, a heating method for heating the dried coated film obtained in the first step and allowing the imidization to proceed so as to obtain the polyimide film, is not particularly limited. Examples thereof include a method in which the heating is performed in two steps. In the case of the heating in two steps, specifically, there are heating conditions as below.

A heating condition of a first step is, for example, preferably a temperature at which a shape of the resin particles is retained. Specifically, for example, the temperature is preferably within a range of 50° C. to 150° C., and is more preferably within a range of 60° C. to 140° C. In addition, a heating time is not limited and is preferably within a range of 10 minutes to 60 minutes. For example, it is preferable that the heating time becomes shorter as the heating temperature becomes higher.

As a heating condition of a second step, heating is performed under conditions of, for example, at 150° C. or higher and 450° C. or lower (preferably 200° C. or higher and 430° C. or lower) for 20 minutes or longer and 120 minutes or shorter. By setting the heating condition within this range, the imidization reaction further proceeds, and therefore the polyimide film may be formed. In a case of the heating reaction, for example, it is preferably that before the temperature reaches a final temperature for the heating, the heating is performed by raising the temperature step by step, or gradually raising the temperature at a certain speed.

The heating condition is not limited to the heating method of two steps as described above, and for example, a method of heating by one step may be adopted. In the case of the method of heating by the first step, for example, the imidization may be completed only by the heating condition shown in the second step.

In the second step, from the viewpoint of increasing a rate of hole area, for example, it is preferable to perform a process of exposing the resin particles so that the resin particles become in a state of being exposed. In the second step, the process of exposing the resin particles is, for example, preferably carried out during the process of imidizing the polyimide precursor or after the imidization, and before the process of removing the resin particles.

In this case, for example, in the case of forming the coated film on the substrate using the resin particle and inorganic particle-dispersed polyimide precursor solution, the resin particle and inorganic particle-dispersed polyimide precursor solution are applied to the substrate, and therefore the coated film in which the resin particles are embedded is formed. Next, the coated film is dried, and thus the dried coated film containing the polyimide precursor and the resin particles is formed. The dried coated film formed by this method is in a state in which the resin particles are embedded. Before heating and performing the process of removing the resin particles from the dried coated film, the process of exposing the resin particles from the polyimide film which is in the process of imidizing the polyimide precursor, or in which the imidization has been completed (after the imidization), may be performed.

In the second step, the process of exposing the resin particles may be performed, for example, when the polyimide film becomes in the following state.

In a case where the process of exposing the resin particles is performed when the imidization ratio of the polyimide precursor in the polyimide film is less than 10% (that is, a state in which the polyimide film may be dissolved in water), examples of the process of exposing the resin particles embedded in the polyimide film include a wiping process, a process of immersing into water, and the like.

In addition, in a case where the process of exposing the resin particles is performed when the imidization ratio of the polyimide precursor in the polyimide film is 10% or more (that is, a state in which the polyimide film is unlikely to be dissolved in water and the organic solvent) and when the polyimide film in which the imidization has been completed is obtained, there are a method of mechanically cutting the resin particles with a tool such as sandpaper to expose the resin particles, and a method of exposing the resin particles by decomposing with a laser and the like.

For example, in the case of the mechanical cutting, a part of the resin particles present in an upper region of the resin particles embedded in the polyimide film (that is, a region of the resin particles on a side away from the substrate) is cut together with the polyimide film present on the upper part of the resin particles, and the cut resin particles are exposed from the surface of the polyimide film.

Thereafter, from the polyimide film from which the resin particles are exposed, the resin particles are removed by the above-described process of removing the resin particles. Therefore, the porous polyimide film from which resin particles are removed is obtained.

In the above description, in the second step, the process of producing the porous polyimide film subjected to the process of exposing the resin particles has been described, but from the viewpoint of increasing the rate of hole area, the resin particles may be subjected to the process exposing the resin particles in the first step. In this case, in the first step, the resin particles may become in the state of being exposed by performing the process of exposing the resin particles in the process of obtaining the coated film, drying the coated film, and thereby forming the dried coated film. By performing the process of exposing the resin particles, the rate of hole area of the porous polyimide film is increased.

For example, in the process of obtaining the coated film containing the polyimide precursor solution, the resin particles, and the inorganic particles, and then drying the coated film to form the dried coated film containing the polyimide precursor, the resin particles, and the inorganic particles, as described above, the dried coated film becomes in a state in which the polyimide precursor is soluble in water. When the dried coated film is in this state, the resin particles may be exposed by, for example, the wiping process, the process of immersing into water, and the like. Specifically, by performing the process of exposing the resin particle layer by, for example, water-wiping the polyimide precursor solution present in a region with a thickness equal to or thicker than a thickness of the resin particle layer, the polyimide precursor solution present in the region with the thickness equal to or thicker than the thickness of the resin particle layer is removed. Then, the resin particles present in a region above the resin particle layer (that is, a region of the resin particle layer on a side away from the substrate) are exposed from the surface of the coat.

For example, it is preferable to provide a skin layer which does not have holes on a surface thereof similarly to a gas separation film, and in this case, it is preferable that the process of exposing the resin particles is not performed, although there is no particular limitation.

In the second step, the substrate for forming the coat used in the first step may be peeled off when the coat is dried, may be peeled off when the polyimide precursor in the polyimide film becomes in the state of being unlikely to be dissolved in the organic solvent, or may be peeled off when the film is in a state where the imidization has been completed.

Through the above-described steps, the porous polyimide film is obtained. The porous polyimide film may be post-processed depending on a purpose of use.

The imidization ratio of the polyimide precursor will be described.

Examples of the partially imidized polyimide precursor include a precursor of a structure having a repeating unit represented by General Formula (I-1), General Formula (I-2), and General Formula (I-3).

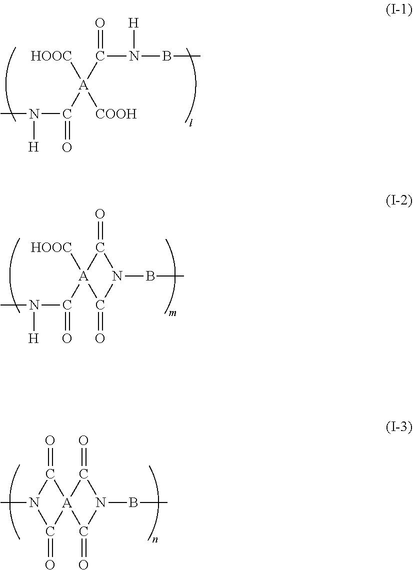

In General Formulas (I-1), (I-2), and (I-3), A represents a tetravalent organic group, and B represents a divalent organic group. 1 represents an integer of 1 or more, and m and n each independently represent an integer of 0 or 1 or more.

A and B are the same as A and B in General Formula (I).

The imidization ratio of the polyimide precursor represents a rate of the number of bonding parts (2n+m) with imide ring closure to a total number of bonding parts (2l+2m+2n) in a bonding part of the polyimide precursor (a reaction part of the tetracarboxylic dianhydride and the diamine compound). That is, the imidization ratio of the polyimide precursor is represented by “(2n+m)/(2l+2m+2n).”

The imidization ratio (value of “(2n+m)/(2l+2m+2n)”) of the polyimide precursor is measured by the following method.

Measurement of Imidization Ratio of Polyimide Precursor

Production of Polyimide Precursor Sample

(i) A coated film sample is produced by applying a polyimide precursor composition to be measured on a silicon wafer in a film thickness range of 1 μm to 10 μm.

(ii) The coated film sample is immersed into tetrahydrofuran (THF) for 20 minutes and the solvent in the coated film sample is replaced with tetrahydrofuran (THF). The solvent into which the film is to be immersed is not limited to THF, and the solvent may be selected from a solvent by which the polyimide precursor does not dissolve, and which is miscible with solvent components contained in the polyimide precursor composition. Specifically, alcohol solvents such as methanol and ethanol, and ether compounds such as dioxane may be used.

(iii) The coated film sample is taken out from the THF, and N2 gas is blown to the THF adhering to a surface of the coated film sample, and therefore THF is removed. The coated film sample is dried by being processed for 12 hours or longer under reduced pressure of 10 mmHg or less and within a range of 5° C. to 25° C., and therefore a polyimide precursor sample is produced.

Production of 100%-Imidized Standard Sample

(iv) In the same manner as in (i), a polyimide precursor composition to be measured is applied on a silicon wafer, and therefore a coated film sample is produced.

(v) The coated film sample is heated at 380° C. for 60 minutes to perform the imidization reaction, and therefore a 100%-imidized standard sample is produced.

Measurement and Analysis

(vi) Infrared absorption spectrum of the 100%-imidized standard sample and the polyimide precursor sample is measured by using a Fourier transform infrared spectrophotometer (FT-730 manufactured by HORIBA, Ltd.). A ratio I′ (100) of an imide bond-derived absorption peak near 1780 cm⁻¹ (Ab′ (1780 cm⁻¹)) to an aromatic ring-derived absorption peak near 1500 cm⁻¹ (Ab′(1500 cm)) of the 100%-imidized standard sample is obtained.

(vii) In the same manner, the measurement is performed on the polyimide precursor sample, and a ratio I(x) of an imide bond-derived absorption peak near 1780 cm⁻¹ (Ab′ (1780 cm⁻¹)) to an aromatic ring-derived absorption peak near 1500 cm⁻¹ (Ab′(1500 cm⁻¹)) of the 100%-imidized standard sample is obtained.

Then, using each measured light absorption peak I′ (100), I(x), the imidization ratio of the polyimide precursor is calculated based on the following formula.

imidization ratio of polyimide precursor=I(x)/I′(100) Formula:

I′(100)=(Ab′(1780 cm⁻¹))/(Ab′(1500 cm⁻¹)) Formula:

I(x)=(Ab(1780 cm⁻¹))/(Ab(1500 cm⁻¹)) Formula:

This measurement of the imidization ratio of the polyimide precursor is applied to a measurement of the imidization ratio of an aromatic polyimide precursor. In a case of measuring the imidization ratio of the aliphatic polyimide precursor, a peak derived from a structure which does not change before and after the imidization reaction is used as an internal standard peak, instead of the absorption peak of the aromatic ring.

Porous Polyimide Film

Hereinafter, the porous polyimide film will be described.

The porous polyimide film contains a resin other than a polyimide resin, and the inorganic particles. In addition, the porous polyimide film may contain the organic amine compound.

A content of the resin other than the polyimide resin is not particularly limited. From the viewpoint of controlling the shape of the pores and the like, the content of the resin other than the polyimide resin, which is contained in the porous polyimide film is, for example, preferably 0.005% by mass or more and 1% by mass or less with respect to a total content of the porous polyimide film. From the same viewpoint, the content of the resin other than the polyimide resin is, for example, more preferably 0.008% by mass or more and 1% by mass or less, and most preferably 0.01% by mass or more and 0.9% by mass or less.

The porous polyimide film may contain the organic amine compound. A content of the organic amine compound is not particularly limited. From the viewpoint of controlling the shape of the pores and the like, the content of the organic amine compound is, for example, preferably 0.001% by mass or more with respect to the total content of a porous polyimide film. From the same viewpoint, a lower limit of the content of the organic amine compound is, for example, preferably 0.003% by mass or more, and more preferably 0.005% by mass or more. An upper limit of the content of the organic amine compound is not particularly limited. For example, the upper limit of the content of the organic amine compound is preferably 1.0% by mass or less, and more preferably 0.9% by mass or less.

An amount of the organic amine compound contained in the porous polyimide film may be controlled by, for example, an amount to be used of the organic amine compound in the first step of the producing steps of the porous polyimide film, a temperature of the heating temperature in the second step, and the like.

As long as the porous polyimide film contains the resin of the resin particles, the resin other than the polyimide resin may not be specifically added to the porous polyimide film, and the resin other than the resin particles may be added to the porous polyimide film as a resin other than the polyimide resin. An amount of the resin other than the polyimide resin contained in the porous polyimide film may be controlled by, for example, an amount to be used of the resin particles in the first step of the producing steps of the porous polyimide film, a condition of the process of removing the resin particles in the second step, and the like.

The presence state of the resin other than the polyimide resin contained in the porous polyimide film is not particularly limited. For example, the resin other than the polyimide resin may be present in at least one of the inside of the porous polyimide film and the surface of the porous polyimide film (including the surface of the pores of the porous polyimide film).

Method for Confirming Content of Organic Amine Compound and Resin Other than Polyimide Resin

The presence and the content of the organic amine compound and the resin other than the polyimide in the porous polyimide film may be measured by, for example, analyzing and quantitatively determining components detected by pyrolysis gas chromatograph mass spectrometry (GC-MS). Specifically, the measurement is performed as follows.

The components contained in the porous polyimide film is analyzed by a gas chromatograph mass spectrometer (GCMS QP-2010 manufactured by Shimadzu Corporation) in which a drop type pyrolyzer (PY-2020D manufactured by Frontier Laboratories Ltd.) is installed.

0.40 mg of the porous polyimide film is accurately weighed and the organic amine compound is measured at a pyrolysis temperature of 400° C.

0.20 mg of the porous polyimide film is accurately weighed and a resin component other than polyimide is measured at a pyrolysis temperature of 600° C. Chromatograms of the pyrolysis temperature of 400° C. and the pyrolysis temperature of 600° C. are compared, and for example, by a condition in which a styrene monomer obtained by depolymerization of polystyrene is detected more at the pyrolysis temperature of 600° C. than at the pyrolysis temperature of 400° C., the resin other than polyimide may be confirmed to be derived from a polymer.

Pyrolyzer: PY-2020D, manufactured by Frontier Laboratories Ltd.

Gas chromatograph mass spectrometer: GCMS QP-2010 manufactured by Shimadzu Corporation

Pyrolysis temperature: 400° C. and 600° C.

Gas chromatography introduction temperature: 280° C.

Injection Method: Split Ratio 1:50

Column: Ultra ALLOY-5, 0.25 μm, 0.25 μm ID, 30 m, manufactured by Frontier Laboratories Ltd.

Gas chromatography temperature program: 40° C.→20° C./min→280° C. for 10 minutes

Mass range: EI, m/z=29-600 (content of resin other than polyimide resin)

Examples of another method for quantitatively determining the amount of the resin other than the polyimide resin contained in the porous polyimide film, include a method in which after hydrolysis of the polyimide resin, resin components other than the polyimide resin is analyzed by using liquid chromatograph (HPLC), nuclear magnetic resonance (NMR), and the like.

Characteristics of Porous Polyimide Film

The porous polyimide film has the spherical pores. The pore may either have a shape in which the pores are connected to each other to be continuous and a shape in which the individual pores have independent shapes, but the shape in which the individual pores have independent shapes is preferable, for example. The average value of the pore diameter is, for example, preferably 0.05 μm or more and 2.5 μm or less, more preferably 0.1 μm or more and 2.0 μm or less, and even more preferably 0.15 μm or more and 1.5 μm or less. The pore diameter may be controlled by a diameter of the particles contained in the polyimide precursor solution.

The spherical shape of the pores includes a spherical shape and a shape close to the spherical shape. In this specification, the term “spherical” in the pore includes both a spherical shape and a nearly spherical shape (a shape close to a spherical shape). Specifically, the spherical shape means that a proportion of particles having a ratio of a major axis to a minor axis (major axis/minor axis) of 1 or more and 1.5 or less is 90% or more. As the ratio of the major axis to the minor axis approaches 1, the shape becomes closer to a spherical shape.

In the porous polyimide film, from the viewpoints of suppressing an increase in the relative dielectric constant of the porous polyimide film and easily improving the heat conductivity, when the relative dielectric constant of the inorganic particles is εi and the volume ratio of the inorganic particles and the pores is Vr 2, a relationship between the relative dielectric constant εi and the volume ratio Vr 2 preferably satisfies Formula 2, although there is no particular limitation.

Vr2>εi−3.4 Formula 2

(Vr 2 is a value represented by a volume (Vv) of a pore/a volume (Vi) of an inorganic filler)

Furthermore, for example, it is more preferable that Formula 2 satisfies a relationship of Vr 2>εi−3.2, and it is even more preferable that Formula 2 satisfies a relationship of Vr 2>εi−3.0.

In the porous polyimide film according to this exemplary embodiment, from the viewpoints of suppressing an increase in the relative dielectric constant of the porous polyimide film and easily improving the heat conductivity, a void volume is, for example, preferably 5% or larger and 80% and smaller. In addition, the void volume is, for example, preferably 10% or larger and 70% or smaller, and more preferably 15% or larger and 60% or smaller. Particularly, a case where the void volume is 15% or larger and 60% or smaller, is excellent for the strength.

In this specification, the term “void volume” is a percentage of a volume of gas in the porous polyimide film with respect to a volume of the porous polyimide film. When an actual volume calculated from a mass and density of solids containing the polyimide, the resin other than the polyimide, and the inorganic particles of the porous polyimide film is set to V0, and an apparent volume including voids of the porous polyimide film is set to V1, the void volume is an amount calculated by (V1−V0)/V1×100.

In the porous polyimide film of this exemplary embodiment, a ratio of a maximum diameter to a minimum diameter of the pores (ratio of a maximum value to a minimum value of the pore diameter) is 1 or more and 2 or less. The ratio is, for example, preferably 1 or more and 1.9 or less, and more preferably 1 or more and 1.8 or less. Among these ranges, the range that is closer to 1 is even more preferable, although there is no particular limitation. By setting the range within this range, variations in the pore diameter are suppressed.

The average value of the pore diameters and the average value of the pore diameters of the portions where the pores are connected to each other are the values observed and measured with a scanning electron microscope (SEM). Specifically, first, the porous polyimide film is cut out, and a sample for measurement is prepared. Then, this sample for measurement is observed and measured by VE SEM manufactured by KEYENCE CORPORATION with generally installed image processing software. The observation and measurement are performed 100 times on each of pore portion in a cross section of the sample for measurement, and an average value, a minimum diameter, a maximum diameter, and an arithmetic mean diameter of each pore portion are obtained. In a case where the shape of the pore is not circular, a longest portion is taken as a diameter.

A film thickness of the porous polyimide film is not particularly limited, but is preferably 10 μm or more and 1000 μm or less.

Application of Porous Polyimide Film

Specific examples of usage to which the porous polyimide film is applied include battery separators such as lithium batteries; separators for electrolytic capacitors; electrolyte films such as fuel cells; battery electrode materials; separation film of gases or liquids; low dielectric constant materials; filtration films; and the like. Furthermore, the porous polyimide film may be applied as a molded article having at least one layer of the porous polyimide film. Specific examples thereof include a printed wiring board (flexible printed wiring board and the like); a high frequency-high voltage electric wire; and the like.

Molded Article

The molded article according to this exemplary embodiment is a molded article having at least one layer of the porous polyimide film. As long as the molded article has at least one layer of the porous polyimide film, the molded article may have a single-layered structure of the porous polyimide film or may be have a multi-layered structure having two or more layers of the porous polyimide film. The layer of the porous polyimide film may have a layer structure according to a purpose.

In addition, as long as the molded article according to this exemplary embodiment has at least one layer of the porous polyimide film, the structure may be a structure in which another porous material (for example, at least one of polyolefin porous film or nonwoven fabric) is laminated. Furthermore, the molded article may have a laminate structure of the at least one layer of the porous polyimide film, and materials other than the porous polyimide film such as a resin material other than the porous film, a metal material, and a ceramic material. In addition, a method for allowing the porous polyimide film to have the laminate structure is not particularly limited, and examples thereof include a known method such as a method of laminating by an adhesive, and a method of directly laminating with other materials without using an adhesive.

A shape of the molded article is not particularly limited, and may be determined according to a purpose. For example, the molded article may have a plate shape, or may have a linear shape or a rod shape.

Hereinafter, as an example of the molded article, a case in which the molded article is an insulated wire in which a surface of a conductor is covered with the porous polyimide film will be described, but the molded article according to this exemplary embodiment is not limited to the insulated wire.

The insulated wire includes a conductor having a wire shape, and the porous polyimide film that covers an outer circumferential surface of the conductor having the wire shape and that contains a resin other than the polyimide resin and inorganic particles. This porous polyimide film functions as an insulating layer. With the insulated wire including this porous polyimide film, an increase in the relative dielectric constant is suppressed, and thus a voltage for initiation of corona discharge is increased. In addition, the heat conductivity is improved, and thus heat generated from the conductor of the insulated wire efficiently dissipates heat. The characteristics of the porous polyimide film are as described above.

A method for covering the outer circumferential surface of the conductor having a flat shape with the porous polyimide film is not particularly limited. For example, the porous polyimide film may be formed in advance according to the above-described method, and then the outer circumferential surface of the conductor having the wire shape may be covered with the porous polyimide film. In addition, the polyimide precursor solution according to this exemplary embodiment may be applied to the outer circumferential surface of the conductor having the wire shape or the flat shape, and then the porous polyimide film may be formed on the outer circumferential surface of the conductor having the wire shape according to the above-described step.

### EXAMPLES

Examples will be described below, but the present invention is not limited to these examples. In the following description, “parts” and “%” are all based on mass unless otherwise specified.

Preparation of Resin Particle Dispersion

Preparation of Resin Particle Dispersion (1)

1000 parts by mass of styrene, 25.0 parts of a surfactant, DOWFAX 2A1 (47% solution, manufactured by Dow Chemical Company), and 576 parts of ion exchange water are mixed and stirred with a dissolver at 1500 rpm for 30 minutes, followed by emulsification, and therefore a monomer emulsion is prepared. Subsequently, 1.10 parts of DOWFAX 2A1 (47% solution, manufactured by Dow Chemical Company) and 1270 parts of ion exchange water are put into a reaction vessel. After heating to 75° C. in a nitrogen stream, 75 parts of the monomer emulsion is added thereto, and then a polymerization initiator solution prepared by dissolving 15 parts of ammonium persulfate in 98 parts of ion exchange water is added dropwise over 10 minutes. After the dropwise addition, the reaction is allowed to proceed for 50 minutes, and then the remaining monomer emulsion is added dropwise over 220 minutes and reacted for further 50 minutes. Subsequently, a solution in which 5.0 parts of maleic acid and 10 parts of ion exchange water are mixed is added dropwise over 5 minutes, the reaction is allowed to proceed for 150 minutes, followed by cooling, and therefore a styrene resin particle dispersion (1) having an acidic group on the surface thereof and having a concentration of solid contents of 34.0% is obtained. This resin particle had an average particle diameter of 0.40 μm and a specific gravity of 1.05.

Production of Resin Particle-Dispersed Polyimide Precursor Solution (PAA-1)

Resin particle dispersion (1): 200 g of ion exchange water is added to 20 g of resin particles (containing about 38 g of water) expressed in terms of solid contents, and the concentration of solid contents of the resin particles is adjusted to 7.7%. 9.59 g (88.7 mmol) of p-phenylenediamine (molecular weight of 108.14) and 25.58 g (86.9 mmol) of 3,3′,4,4′-biphenyl tetracarboxylic dianhydride (molecular weight of 294.22) are added thereto, stirred at 20° C. for 10 minutes, and dispersed. Subsequently, 25.0 g (247.3 mmol) of N-methylmorpholine (organic amine compound), 15 g of N-methylpyrrolidone, and 30 g of water are slowly added and mixed in a solution, and dissolved by stirring for 24 hours while maintaining a reaction temperature at 60° C. so as to allow the reaction, and therefore a resin particle-dispersed polyimide precursor solution (PAA-1) (resin particle/polyimide precursor=20/39.1 (mass ratio)) is obtained. When the obtained PAA-1 is diluted with water and measuring a particle size distribution is measured, similarly to the resin particle dispersion (1), an average particle diameter had a single peak of 0.40 μm, which is a favorable dispersion state.

Production of Polyimide Precursor NMP Solution (PAA-2)

250 g of N-methylpyrrolidone (NMP), 9.59 g (88.7 mmol) of p-phenylenediamine (molecular weight of 108.14) and 25.58 g (86.9 mmol) of 3,3′,4,4′-biphenyl tetracarboxylic dianhydride (molecular weight of 294.22) are stirred at 20° C. for 10 minutes, and dispersed. Subsequently, the mixture is dissolved by stirring for 24 hours while maintaining a reaction temperature at 60° C. so as to allow the reaction, and therefore a polyimide precursor solution (PAA-2) is produced.

### Example 1

0.3 parts of boron nitride (UHP-1K, manufactured by SHOWA DENKO K.K., volume-based average particle diameter of 8 μm, specific gravity of 2.27, relative dielectric constant of 3.9) is added to 20 parts of the resin particle-dispersed polyimide precursor solution (PAA-1) and is sufficiently mixed, and then further mixed by THINKY MIXER (AR-100, manufactured by Thinky Corporation), and subjected to a defoaming process, and then is applied to a roughened surface of an electrolytic copper foil (F2-WS, thickness: 18 μm, manufactured by FURUKAWA ELECTRIC CO., LTD.). After drying at 80° C. for 10 minutes, a temperature is raised to 400° C. at 30° C./min and held at 400° C. for 30 minutes. After cooling to room temperature, a porous polyimide film having a film thickness of 30 μm is obtained. After sufficiently drying, the heat conductivity is measured by the following procedure. In addition, a gold electrode is vapor-deposited on the obtained porous polyimide film, and the dielectric constant is measured. Furthermore, a peeling test of this laminate is carried out.

### Examples 2 to 6 and Comparative Example 1

A film is produced in the same manner as in Example 1 except that the type and the amount of the inorganic particles are changed according to Table 1, and evaluated.

### Comparative Example 2

1.3 parts by mass of cross-linked polymethyl methacrylate (SSX-101, manufactured by Sekisui Plastic Co., Ltd.) having an average particle diameter of 1 μm, and 0.3 parts by mass of boron nitride (UHP-1K, manufactured by SHOWA DENKO K.K., average particle diameter of 8 μm, specific gravity of 2.27, relative dielectric constant of 3.9) are added to 20.9 parts by mass of the polyimide precursor NMP solution (PAA-2), mixed by THINKY MIXER (AR-100, manufactured by Thinky Corporation), and subjected to a defoaming process, and then is applied to a glass plate. After cooling to room temperature, the glass plate is immersed into water so that the film is peeled off, and the evaluation is performed in the same manner as in Example 1. As a result, the formation of the pores is rarely observed by dissolution of the resin particles.

### Reference Example

The polyimide precursor solution (PAA-2) is applied to the glass plate and dried, and then the temperature is raised to 400° C. over 20 minutes and held for one hour, and therefore the film of 30 μm is obtained. When the specific gravity and the dielectric constant of the obtained film are measured, the specific gravity is 1.42 and the dielectric constant is 3.2.

Measurement of Relative Dielectric Constant

In regard to the relative dielectric constant, a complex dielectric constant at a frequency of 1 GHz is measured by a cavity resonator perturbation method, and a real part (εr′) is taken as the relative dielectric constant.

A dielectric loss tangent (tan δ) is obtained from a ratio (εr″/εr′) of the real part (εr′) and the imaginary part (εr″).

The measurement is performed on a rectangular test piece (2 mm width×70 mm length) by a cylindrical cavity resonator (“Network analyzer N5230C”, manufactured by Agilent Technologie, and “cavity resonator 1 GHz” manufactured by Kanto Electronic Application and Development Inc.) as a measuring apparatus.

Measurement of Heat Conductivity

The obtained porous polyimide film is cut into a 30 mm square and measured using a heat conductivity measuring instrument (ai-Phase Mobile manufactured by ai-Phase Co., Ltd.).

Peeling Test

Mending tape (manufactured by 3M Company) is attached to a surface and a rear surface of the laminate of the porous polyimide film on which the gold electrode is vapor-deposited as described above, the peeling is performed in a direction of peeling off the both surfaces (a direction in which the mending tape adhered to the surface and the rear surface became) 90°, and therefore the presence or absence of peeling between the porous polyimide film and the gold electrode is tested and evaluated according to the following evaluation standard.

Evaluation Standard

A: No peeling

B: Peeling occurred in some parts

C: All surfaces are peeled off

TABLE 1

| | | | | | | | | | Com- | Com- | Ref- |
|---|---|---|---|---|---|---|---|---|---|---|---|
| | | | | | | | | | parative | parative | erence |
| | | | Exam- | Exam- | Exam- | Exam- | Exam- | Exam- | Exam- | Exam- | Exam- |
| | | | ple 1 | ple 2 | ple 3 | ple 4 | ple 5 | ple 6 | ple 1 | ple 2 | ple |
| PI precursor | Inorganic | Type | BN | BN | Al₂O₃ | BN | BN | Al₂O₃ | — | BN | — |
| solution | particle | Volume | 8 | 8 | 4.6 | 8 | 8 | 4.6 | — | 8 | — |
| (Resin | | average | | | | | | | | | |
| particle and | | particle | | | | | | | | | |
| inorganic | | diameter | | | | | | | | | |
| particle | | Relative | 3.9 | 3.9 | 8.5 | 3.9 | 3.9 | 8.5 | — | 3.9 | — |
| dispersion) | | dielectric | | | | | | | | | |
| | | constant | | | | | | | | | |
| | | (∈i) | | | | | | | | | |
| | | Amount (g) | 0.3 | 0.6 | 0.5 | 2.5 | 5 | 1 | — | 0.3 | — |
| | | Specific | 2.27 | 2.27 | 3.98 | 2.27 | 2.27 | 3.98 | — | 2.27 | — |
| | | gravity | | | | | | | | | |
| | | Volume (Vi) | 0.13 | 0.26 | 0.13 | 1.10 | 2.20 | 0.25 | — | 0.13 | — |
| | Resin | Amount (g) | 20.00 | 20.00 | 20.00 | 20.00 | 20.00 | 20.00 | 20.00 | 20.90 | — |
| | particle- | | | | | | | | | | |
| | dispersed PI | | | | | | | | | | |
| | precursor | | | | | | | | | | |
| | solution | | | | | | | | | | |
| | Resin | Amount (g) | 1.10 | 1.10 | 1.10 | 1.10 | 1.10 | 1.10 | 1.10 | 1.30 | — |
| | particle | Specific | 1.05 | 1.05 | 1.05 | 1.05 | 1.05 | 1.05 | 1.05 | 1.19 | — |
| | | gravity | | | | | | | | | |
| | | Volume (Vp) | 1.05 | 1.05 | 1.05 | 1.05 | 1.05 | 1.05 | 1.05 | 1.09 | — |
| | PI | Amount (g) | 1.94 | 1.94 | 1.94 | 1.94 | 1.94 | 1.94 | 1.94 | 1.94 | — |
| | precursor | Specific | 1.47 | 1.47 | 1.47 | 1.47 | 1.47 | 1.47 | 1.47 | 1.47 | — |
| | | gravity | | | | | | | | | |
| | | Volume | 1.32 | 1.32 | 1.32 | 1.32 | 1.32 | 1.32 | 1.32 | 1.32 | — |

| | | | | | | | | | | |
|---|---|---|---|---|---|---|---|---|---|---|
| | Vr 1 (Vp/Vi) | 7.94 | 3.97 | 8.35 | 0.95 | 0.48 | 4.17 | — | 8.27 | — |
| | ∈i − 3.4 | 0.50 | 0.50 | 5.10 | 0.50 | 0.50 | 5.10 | — | 0.50 | — |
| | ∈i − 3.2 | 0.70 | 0.70 | 5.30 | 0.70 | 0.70 | 5.30 | — | 0.70 | — |
| | ∈i − 3.0 | 0.90 | 0.90 | 5.50 | 0.90 | 0.90 | 5.50 | — | 0.90 | — |
| Molded | Relative dielectric constant | 2.6 | 2.8 | 3.0 | 3.1 | 3.5 | 3.6 | 2.0 | 3.3 | 3.2 |
| article | | | | | | | | | | |
| (porous | Average pore diameter | About | About | About | About | About | About | About | Almost | None |
| PI film) | | 0.35 to | 0.35 to | 0.35 to | 0.35 to | 0.35 to | 0.35 to | 0.35 to | none | |
| | | 0.4 μm | 0.4 μm | 0.4 μm | 0.4 μm | 0.4 μm | 0.4 μm | 0.4 μm | | |
| | Shape of pore | Almost | Almost | Almost | Almost | Almost | Almost | Almost | | |
| | | spherical | spherical | spherical | spherical | spherical | spherical | spherical | | |
| | Vr 2 (Vv/Vi) | 7.01 | 3.45 | 7.52 | 0.85 | 0.44 | 3.89 | — | — | — |
| | ∈i − 3.4 | 0.50 | 0.50 | 5.10 | 0.50 | 0.50 | 5.10 | — | 0.50 | — |
| | ∈i − 3.2 | 0.70 | 0.70 | 5.30 | 0.70 | 0.70 | 5.30 | — | 0.70 | — |
| | ∈i − 3.0 | 0.90 | 0.90 | 5.50 | 0.90 | 0.90 | 5.50 | — | 0.90 | — |
| | Heat conductivity (W/m · K) | 8.52 | 16.01 | 4.31 | 26.33 | 42.55 | 8.36 | 0.10 | 6.01 | 0.16 |
| | Adhesiveness | A | A | A | B | C | A | A | C | — |
| | Amount of organic amine | 0.035 | 0.025 | 0.034 | 0.011 | 0.009 | 0.026 | 0.041 | Not | — |
| | compound (% by mass) | | | | | | | | detected | |
| | Monomer derived from resin | 0.025 | 0.018 | 0.023 | 0.015 | 0.011 | 0.019 | 0.031 | 0.025 | — |
| | particle (% by mass) | | | | | | | | | |

In Table 1, the term. “PI” represents polyimide, the term “BN” represents boron nitride, and the term. “Al₂O₃” represents aluminum oxide.

Based on the above results, it is found that the results of the relative dielectric constant and the heat conductivity are favorable in this example compared to the comparative example. Therefore, in this example, as compared to the comparative example, it is found that an increase in the relative dielectric constant is suppressed and the heat conductivity is improved.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments are chosen and describes in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A polyimide precursor solution, comprising:
an aqueous solution that contains water;
a resin particle that does not dissolve in the aqueous solution;
an inorganic particle; and
a polyimide precursor.

2. The polyimide precursor solution according to claim 1,
wherein the inorganic particle is at least one selected from the group consisting of a metal nitride, a metal carbide, and a metal oxide.

3. The polyimide precursor solution according to claim 1,
wherein the inorganic particle is selected from the group consisting of boron nitride, silicon nitride, aluminum nitride, silicon carbide, aluminum oxide, magnesium oxide, zinc oxide, and beryllium oxide.

4. The polyimide precursor solution according to claim 1,
wherein the polyimide precursor solution satisfies Formula 1,
Vr1>εi−3.4 Formula 1
provided that εi is a relative dielectric constant of the inorganic particle, and Vr 1 is a value represented by a volume Vp of the resin particle/a volume Vi of the inorganic particle.

5. The polyimide precursor solution according to claim 1, further comprising:
an organic amine compound.

6. The polyimide precursor solution according to claim 5,
wherein the organic amine compound is a tertiary amine compound.

7. The polyimide precursor solution according to claim 5,
wherein the organic amine compound is selected from the group consisting of 2-dimethylaminoethanol, 2-diethylaminoethanol, 2-dimethylaminopropanol, pyridine, triethylamine, picoline, N-methylmorpholine, N-ethylmorpholine, 1,2-dimethylimidazole, 2-ethyl-4-methylimidazole, N-methylpiperidine, and N-ethylpiperidine.

8. A molded article, comprising:
a porous polyimide layer that contains an inorganic particle; and a resin other than a polyimide resin.

9. The molded article according to claim 8,
wherein the resin other than the polyimide resin is a resin having a non-crosslinked structure.

10. The molded article according to claim 8,
wherein a content of the resin other than the polyimide resin is within a range of 0.005% by mass to 1.0% by mass with respect to a total content of the porous polyimide layer.

11. The molded article according to claim 8,
wherein the porous polyimide layer satisfies Formula 2,
Vr2>εi−3.4 Formula 2
provided that εi is a relative dielectric constant of the inorganic particle, and Vr 2 is a value represented by a volume (Vv) of a pore/a volume (Vi) of an inorganic filler.

12. The molded article according to claim 8,
wherein the porous polyimide layer further includes an organic amine compound.

13. The molded article according to claim 12,
wherein the organic amine compound is a tertiary amine compound.

14. The molded article according to claim 12,
wherein the organic amine compound is selected from the group consisting of 2-dimethylaminoethanol, 2-diethylaminoethanol, 2-dimethylaminopropanol, pyridine, triethylamine, picoline, N-methylmorpholine, N-ethylmorpholine, 1,2-dimethylimidazole, 2-ethyl-4-methylimidazole, N-methylpiperidine, and N-ethylpiperidine.

15. The molded article according to claim 12,
wherein a content of the organic amine compound is 0.001% by mass or more with respect to a total content of the porous polyimide layer.

16. The molded article according to claim 12,
wherein a content of the organic amine compound is within in a range of 0.005% by mass to 1.0% by mass with respect to a total content of the porous polyimide layer.

17. A method for producing a molded article including a porous polyimide layer, comprising:
applying the polyimide precursor solution according to claim 1 to form a coated film, and then drying the coated film, thereby forming a dried coated film that contains the polyimide precursor, the resin particle, and the inorganic particle; and
heating the dried coated film to imidize the polyimide precursor, thereby forming a polyimide layer,
wherein the heating includes removing the resin particle.

18. The method for producing a molded article according to claim 17,
wherein the resin particle is removed only by heating.
